(19) United States
(12) Patent Application Publication
(10) Pub. No.: US 2025/0232385 A1
(43) Pub. Date: Jul. 17, 2025

(54) TRACING DATA ENTRIES AND EVIDENCE ACROSS RECORDS AND SYSTEMS

(71) Applicant: VALID8 Financial Inc., Seattle, WA (US)

(72) Inventors: Christopher Donald McCall, Boulder, CO (US); David Austin Gallant, Denver, CO (US); Tod Robert McDonald, Seattle, WA (US)

(21) Appl. No.: 19/097,582

(22) Filed: Apr. 1, 2025

Related U.S. Application Data
(63) Continuation-in-part of application No. 17/347,026, filed on Jun. 14, 2021.
Application No. 17/347,026 is a continuation of application No. 16/742,646, filed on Jan. 14, 2020, now Pat. No. 11,062,400.

(51) Int. Cl. G06Q 40/12; G06F 18/2321; G06F 21/16; G06N 20/00; H04L 9/32

(52) U.S. Cl. CPC G06Q 40/125; G06F 18/2321; G06F 21/16; G06N 20/00; H04L 9/32; H04L 2209/56

(57) ABSTRACT

Systems and methods of tracing records across different systems are provided. Data entries within record files stored at a recordkeeping system may be monitored. A set of the data entries from across different record files may be identified as being associated. Evidence entries stored at an evidence system may be identified as corresponding to the set of associated data entries. A trace object may be generated that is defined based on the set of associated data entries and the corresponding evidence entries. A verification disposition may be generated for the trace object based on a comparison of the set of associated data entries to the corresponding evidence entries. A diagram may be generated that visually represents trace status for the record files in the recordkeeping system, wherein the diagram includes a plurality of trace objects including the defined trace object and corresponding verification dispositions including the generated verification disposition.

### CROSS-REFERENCE TO RELATED APPLICATIONS

The present patent application is a continuation-in-part and claims the priority benefit of U.S. patent application Ser. No. 17/347,026 filed Jun. 14, 2021, which is a continuation and claims the priority benefit of U.S. patent application Ser. No. 16/742,646 filed Jan. 14, 2020 and issued as U.S. Pat. No. 11,062,400, the disclosure of which are incorporated by reference herein.

### BACKGROUND OF THE INVENTION

### 1. Field of the Disclosure

The present disclosure is generally related to digital data record management. More particularly, the present disclosure relates to generating traces for determining matches among data entries of digital records sourced from different independent systems and transforming data structures in accordance with evidentiary data.

### 2. Description of the Related Art

Different independent recordkeeping systems may maintain a variety of different digital files that include record data structured in accordance with a data structure that may be specific to the respective recordkeeping system. The different recordkeeping systems may maintain the same or similar data for different purposes, and as such, the respective data structures for maintaining the respective record files in each system may be different. As such, data maintained by the different recordkeeping systems may not be easily discernible as pertaining to the same subject matter. For example, some accounting systems may use relational databases organized by accounts and dual entries (e.g., where debits and credits sum to 0 when the entries are complete and accurate). Because a system based on dual entries is structured by account, it may be difficult to identify how transactions (associated with a set of dual entries) and dual entries may be related to one another. Meanwhile, other record systems may define a transaction differently, and its records pertaining to the same transaction may be structured and presented in accordance with such differences. As such, the task of verifying the accuracy of data within a record file maintained by one recordkeeping system may be complicated by the challenges of identifying corresponding evidentiary data that is being independently maintained within a different data structure by a different recordkeeping system.

Presently available methods for auditing such records rely on random sampling data entries and testing the randomly selected entries against user-identified evidence. Not only would such auditing be time-consuming and not scalable due to reliance on user-identified evidence, but such audits are limited to the samples—which may represent only a small percentage of the overall database of files. Such audits may thus fail to detect data entries that are inconsistent with evidence or backup data from independent or third-party verification sources.

For accounting records, such independent verification sources may include detailed statements of transactions as provided from online computing systems of banks, other financial institutions, or other independent, third-party entities involved in the transaction. Due to such differences between systems and data structures, data kept in one recordkeeping system cannot be easily compared or matched to data kept in a different recordkeeping system, which complicates the process of matching a particular data entry to evidentiary data that substantiates or backs up the accuracy of the data entry.

There is therefore a need in the art for improved systems and methods of tracing digital data entry matches and evidence across different systems.

### SUMMARY OF THE CLAIMED INVENTION

Embodiments of the claimed invention include systems and methods of tracing records across different systems. Data entries within record files stored at a recordkeeping system may be monitored. A set of the data entries from across different record files may be identified as being associated. Evidence entries stored at an evidence system may be identified as corresponding to the set of associated data entries. A trace object may be generated based on the set of associated data entries and the corresponding evidence entries. A verification disposition may be generated for the trace object based on a comparison of the set of associated data entries to the corresponding evidence entries. A diagram may be generated that visually represents trace status for the record files in the recordkeeping system, wherein the diagram includes a plurality of trace objects including the defined trace object and corresponding verification dispositions including the generated verification disposition.

### BRIEF DESCRIPTION OF THE FIGURES

FIG. 1 illustrates an exemplary network environment in which a system for tracing digital data entry matches and evidence may be implemented.

FIG. 2A illustrates an exemplary recordkeeping system for maintaining records of data corresponding to evidence data maintained in a separate system.

FIG. 2B illustrates sets of data entries determined to be related across records of the recordkeeping system and the evidence system of FIG. 2A.

FIG. 2C illustrates a trace for each set of data entries determined to be related across the recordkeeping system and the evidence system of FIG. 2A.

FIGS. 3A-C illustrates the individual traces generated for each set of data entries determined to be related across the recordkeeping system and the evidence system of FIG. 2A.

FIG. 4 is a Sankey diagram that provides a visualization of trace completeness matches for data entries from a recordkeeping system and corresponding evidence.

FIG. 5 is a flowchart illustrating an exemplary method for tracing digital data entry matches and evidence.

FIG. 6 is a block diagram of an exemplary computing device that may be used to implement an embodiment of the present invention.

### DETAILED DESCRIPTION

Embodiments of the claimed invention include systems and methods of tracing records across different systems. Data entries within record files stored at a recordkeeping system may be monitored. A set of the data entries from across different record files may be identified as being associated. Evidence entries stored at an evidence system may be identified as corresponding to the set of associated data entries. A trace object may be generated based on the set of associated data entries and the corresponding evidence entries. A verification disposition may be generated for the trace object based on a comparison of the set of associated data entries to the corresponding evidence entries. A diagram may be generated that visually represents trace status for the record files in the recordkeeping system, wherein the diagram includes a plurality of trace objects including the defined trace object and corresponding verification dispositions including the generated verification disposition.

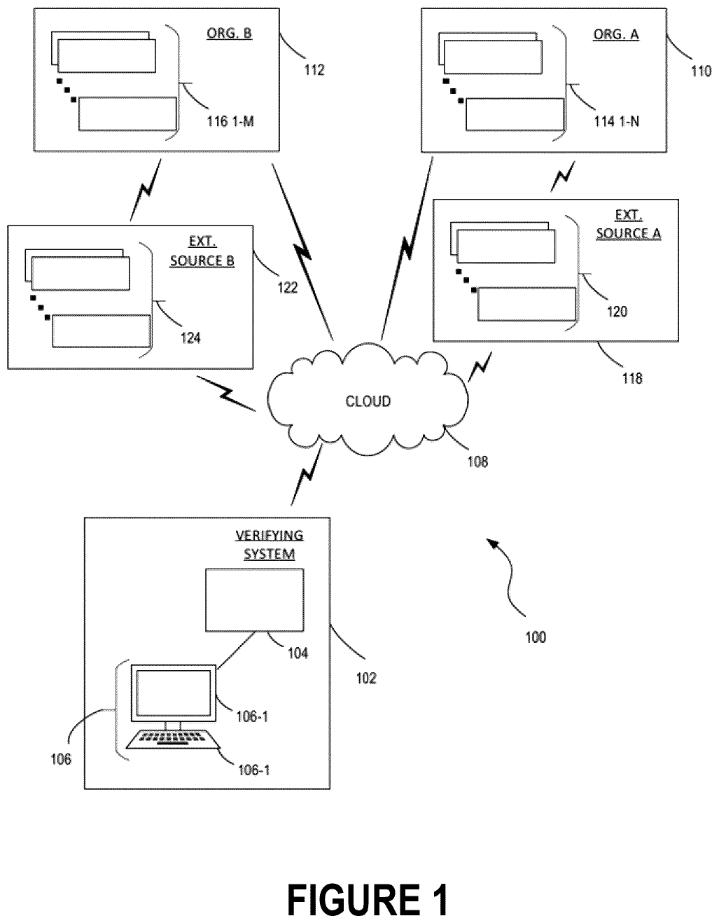

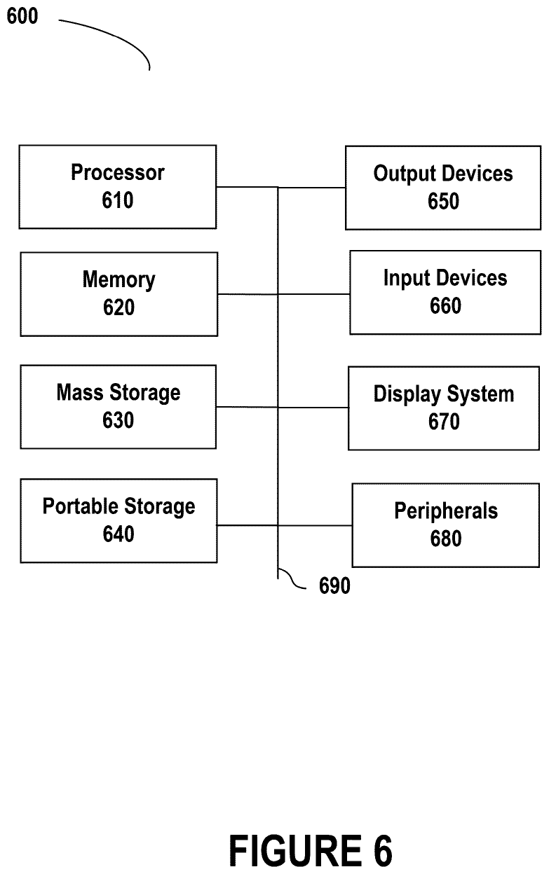

FIG. 1 illustrates an exemplary network environment 100 in which a system for tracing digital data entry matches and evidence may be implemented. Network environment 100 of FIG. 1 includes a verifying system 102, independent recordkeeping system 110 (e.g., associated with organization A), independent recordkeeping system 112 (e.g., associated with organization B), and independent external evidence sources such as evidence system 120, and evidence system 122. The different systems—verifying system 102, recordkeeping system 110, recordkeeping system 112, evidence system 120, and evidence system 122—may communicate with each other over cloud communication network 108. In addition, the different systems may include or be embodied in computing devices such as that discussed in further detail in relation to FIG. 6.

Verifying system 102 may include various computing devices and components including, but not limited to, server 104 and station 106. Server 104—which may correspond to a computing device such as that discussed in relation to FIG. 6—may include one or more processors that are configured to execute computer-readable instructions to perform trace generation and trace-based data verification against evidence as described herein. Station 106 may include a display 106-1 on which a graphical user interface (GUI) may be presented to receive input related to implementing trace generation and trace-based data verification as described in further detail herein. Station 106 may optionally include input device 106-2 for inputting and providing commands to carry the trace-based data verification process. Station 106 may be any other known or to be developed end user device including but not limited to, a desktop computing device, laptop, a mobile device, a tablet, etc.

In one example, server 104 may be located remotely relative to station 106 and may be accessible via cloud communication network 108 using any known or to be developed wired and/or wireless communication scheme. In another example, functionalities of server 104 may be distributed across several servers providing virtual processing power operated by a single or multiple cloud service providers (private, public or hybrid of both).

Cloud communication network 108 may be a local, proprietary network (e.g., an intranet) and/or may be a part of a larger wide-area network. The cloud communications network 108 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Cloud communication network 108 allows for communication between the various components of network environment 100.

Network environment 100 may also include exemplary recordkeeping system 110 and recordkeeping system 112, each of which may maintain record files that may be structured and organized in accordance with a data structure specific to the recordkeeping system 110 and its respective rules, policies, and parameters. Each record file may include entries for different types of data in accordance with the data structure. The number of recordkeeping systems having data records subject to analysis, tracing, and verification by verifying system 102 is not limited to two as shown in FIG. 1 and may include more or fewer systems.

Recordkeeping system 110 and recordkeeping system 112 may each include a data processing system that records data that may be collected, analyzed, and entered into record files, e.g., using accounting or ledger software or any other software package for keeping and organizing digital records. As shown in FIG. 1, recordkeeping system 110 may have associated records (data set) 114 1-N stored in a respective database, where N is an integer greater than or equal to 1 and may corresponding to the number of different records of recordkeeping system 110. Recordkeeping system 112 may have associated records (data set) 116 1-M stored in a respective database, where M is an integer greater than or equal to 1 and may corresponding to the number of different records of recordkeeping system 110. M and N may be the same or different. As noted above, each one of records 114 1-N and 116 1-M may be include different types of record files that are relevant to the specific recordkeeping system 110 or recordkeeping system 112. Where a recordkeeping system 110 may be relevant to accounting, for example, the record files may include, but are not limited to, a balance sheet, an income statement, a cash journal, an account receivables statement, an account payables statement, an assets statement, and a liability statement.

Network environment 100 further illustrates an independent external evidence source associated with each of recordkeeping system 110 and recordkeeping system 112. External evidence source A 118 may be, for example, an independent, third-party institution involved in generating or otherwise documenting data recorded by recordkeeping system 110. For example, a computing system of a bank or other financial institution may independently maintain its own data files regarding transactions that generate data captured in the record files. Accordingly, external evidence source A 118 may have records stored in a relevant database (independently-sourced data set) 120 that pertain to the same actions, operations, or transactions also documents in record files of recordkeeping system 110, and as described herein, can be used to verify the data entries of recordkeeping system 110 using trace-based data verification.

External evidence source B 122 may be, for example, an online computing system of a financial institution or a bank that is used to conduct financial transactions about which recordkeeping system 112 may also maintain its own set of record files. Accordingly, external evidence source B 122 may have records stored in a relevant database (independently-sourced data set) 124 that reflect the same transactions that are the subject of records files maintained by recordkeeping system 112, and as described herein, can be used to verify the records of recordkeeping system B 112 using trace-based data verification.

In one example, a single external evidence source (either external evidence source A 118 or external evidence source B 122) may be associated with both recordkeeping systems A 110 and B 112. Furthermore, there may be more than one external evidence source associated with a single recordkeeping system that has independently-sourced data available to be used in trace generation and trace-based data verification for that single recordkeeping system. As described herein, verifying system 102 may access and retrieve any data sets from among the different recordkeeping systems 110 and 112 and evidence sources 118 and 122 (e.g., data sets 114 1-N, 116 1-M, independently-sourced data sets 120 and 124) using any Application Programming Interface (API) associated with the respective computing systems.

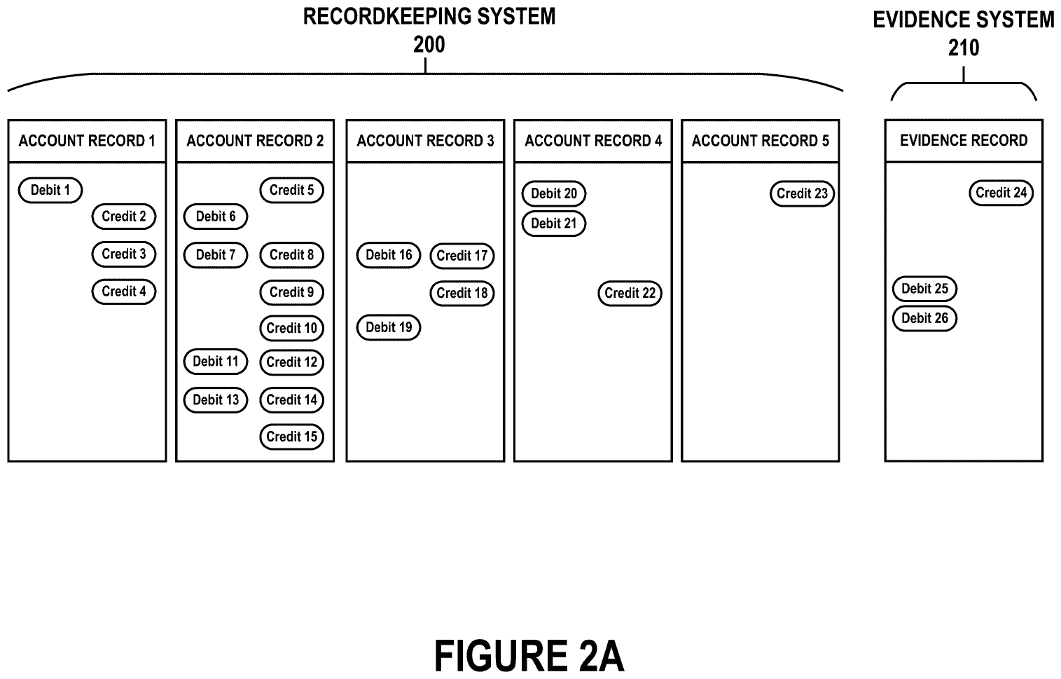

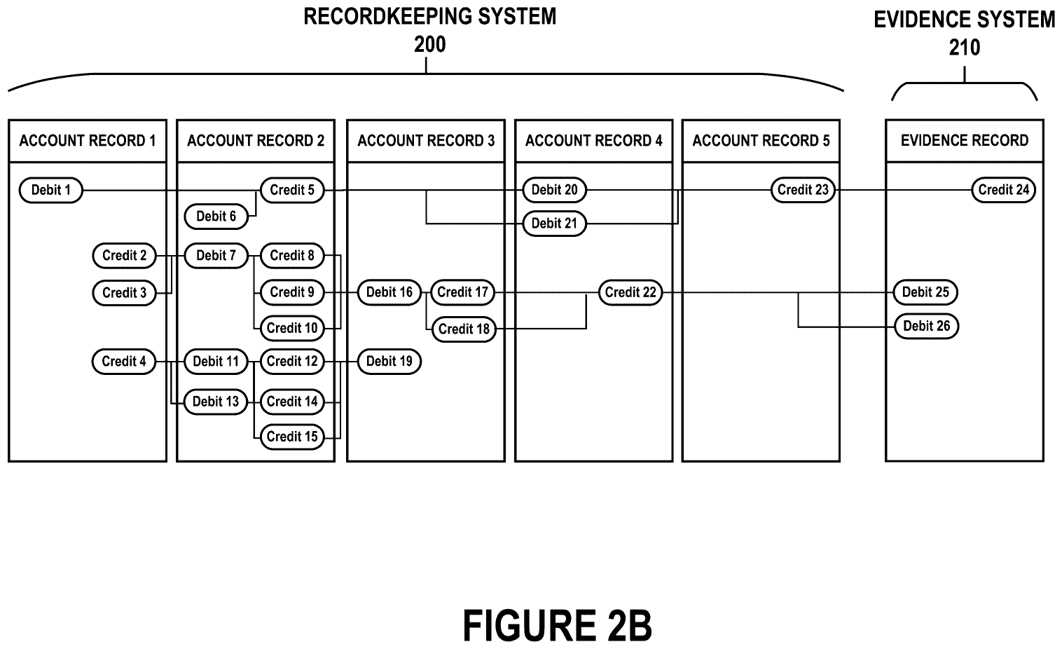

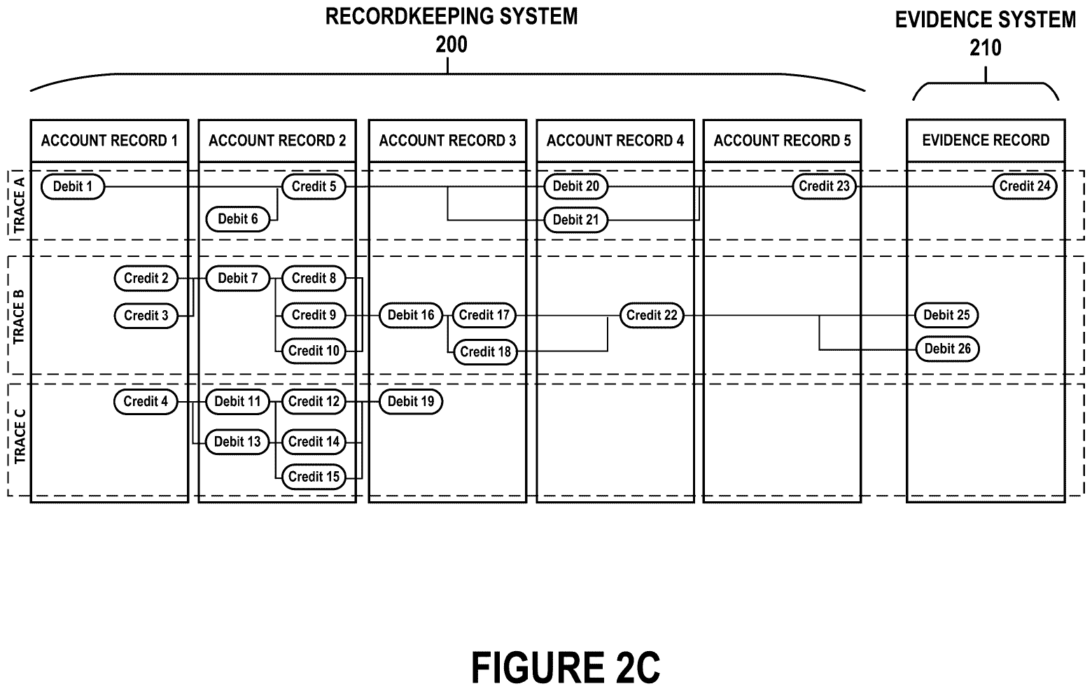

FIG. 2A illustrates an exemplary recordkeeping system 200 for maintaining records of data corresponding to evidence data maintained in a separate evidence system 210. As illustrated, recordkeeping system 200 maintains its data records in a data structure that is organized by defined accounts. As such, each record is associated with a different account, and there is a respective account record for each individual account. The specific recordkeeping system 200 illustrated by FIG. 2A further reflects a data structure specific to double-entry bookkeeping practices whereby separate data entries are maintained for debits and credits associated with a transaction. Recordkeeping system 200 may therefore maintain distinct record files for each account, and each record file may include data entries regarding different data points (e.g., debits and credits) associated with the account. FIG. 2A additionally illustrates an independent evidence system 210 that maintains its own set of files recording data associated with the same subject matter as stored in recordkeeping system 200. For example, evidence system 210 may be an online computing system of a service provider used in operations involving different accounts (e.g., associated with account record 1, 2, 4, and 5). Despite being involved in the same operation, therefore, the specific data entries regarding that operation that is maintained in account record 1 may differ from the data entries regarding that same operation as maintained in account record 2, as well as differ from the data entries regarding that same operation as maintained in account record 4 and from the data entries regarding that same operation as maintained in account record 5.

FIG. 2B illustrates sets of data entries determined to be related across the recordkeeping system 200 and the evidence system 210 of FIG. 2A. Such relationships may be based on being part of or otherwise having relevance to the same action, operation, or transaction. Verifying system 102 (not pictured) may access or otherwise monitor recordkeeping system 200 to mine record data for associations, identify missing associations, and generate new associations so as to provide a comprehensive view of all related operations or transactions. Such mining by verifying system 102 may therefore detect that one or more data entries are not yet associated with any other data entries. Such mining may occur continuously, periodically, or be triggered (e.g., addition of new data entry, request by user, etc.). Finding and generating accurate associations between different data entries (which may reside within different record files, as well as different recordkeeping and evidence source systems) may be based on a variety of matching parameters. Such matching parameters may include contextual information associated with the particular systems (e.g., type of recordkeeping system, specific entity associated with the recordkeeping system, type of entity, type of data structure, type of record, specific record, account, etc.), as well as contextual information associated with the common subject matter (e.g., data or metadata regarding the transaction, action, operation, etc.) characterized by or otherwise associated with the data.

Verifying system 102 may also use contextual information to interpret or translate the data from the respective record file, data structure, and recordkeeping system. For example, different systems may define, record, or present data regarding the same action differently. As such, verifying system 102 may utilize context awareness to determine how to normalize or otherwise interpret the data entry such that it can be analyzed consistently with other data entries from other types of records, data structures, recordkeeping systems, and evidence systems. For example, verifying system 102 may use contextual information to determine whether different types of financial records files (e.g., by account and account type) may be a positive or negative number. As a result, verifying system 102 may be able to determine that a set of data entries—whether in the same or different record file, recordkeeping system, or evidence system—may be associated with each other. In the illustrated example of FIG. 2A, the related data entries (e.g., set of different debits and credits across different account records and recordkeeping and evidence systems) are shown as being connected by lines.

FIG. 2C illustrates a trace for each set of data entries determined to be related across the recordkeeping system 200 and the evidence system 210 of FIG. 2A. Following the identification of different sets of data entries as being associated with each other, verifying system 102 may generate a trace for each respective set of data entries. As used herein, a trace is an unstructured or semi-structured data object (e.g., lacking the strict predefined schema of relational databases or other structured databases). Each trace object generated by verifying system may be defined based on the respective set of data entries determined to be associated with each other. Because such trace objects are unstructured (or at least less structured than recordkeeping system 200), a trace object may therefore be defined in a way that encompasses data entries from across different records and systems. Due to its lack of structure or less structured nature, the trace object may be used to more efficiently and accurately analyze, compare, and identify associated data entries from different data structures such as maintained in independent, third party evidence systems.

The trace object may therefore associated data entries from within the same account record and across different account records, across the same and different types of account records and systems, across different transaction definitions from different types of data structures (e.g., associated with different accounting systems for general ledgers, accounting system subledgers, 3^{rd} party ledgers, bank statements, transaction lists of any digital format, etc.). As illustrated by FIG. 2C, trace A may be generated and defined to include data entries from within the same and different record files (e.g., account record 1, account record 2, account record 4, account record 5, evidence record) and systems (e.g., recordkeeping system 200 and evidence system 210). Similarly, trace B is illustrated as being defined in accordance with data entries from account record 1, account record 2, account record 3, and account record 4 of recordkeeping system 200 and from the evidence record of evidence system 210; and trace C is illustrated as being defined in accordance with data entries from account record 1, account record 2, and account record 3 of recordkeeping system 200.

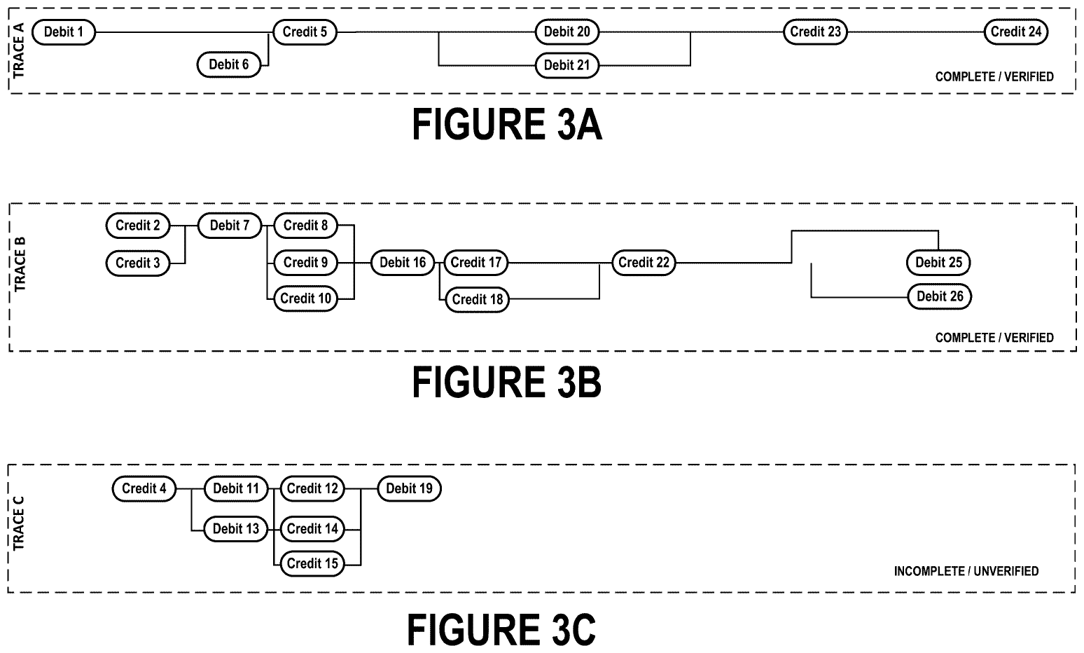

FIGS. 3A-C illustrates the individual traces A-C generated for each set of data entries determined to be related across the recordkeeping system 200 and the evidence system 210 of FIG. 2A. As verifying system 102 monitors recordkeeping system 200, different traces may be generated and defined in accordance with data entries determined to be related. As the trace objects are defined for the data entries of recordkeeping system 200, verifying system 102 may also assess the completeness of and verification disposition (e.g., whether the records of recordkeeping system 200 are associated with evidence and consistency with the evidence) of each trace. Trace A and trace B further include one or more data entries from the evidence record of evidence system 210. As such, they are marked as complete and verified in FIGS. 3A and B respectively. Trace C, however, lacks any association to evidence data, and as such, is marked “incomplete” and “unverified.”

Verifying system 102 may also assess confidence of completeness. Where a set of data entries may be suspected of being associated, verifying system 102 may generate a series of quality metrics that may be used to infer a confidence level regarding completeness of the assessment. Verifying system 102 may further generate a quantified confidence level score and quality metrics summarized to indicate the confidence level of how well a set of data entries (e.g., identified as potentially associated with the same accounting transaction) matches to corresponding evidence.

Each trace may also be defined in accordance with specific properties that allow verifying system 102 to assess completeness and verification. For example, verifying system 102 may define each trace object such that the data entries are associated with only a single trace object and that each trace object has a verification disposition that can be applied to the set of data entries (e.g., associated with the same transaction(s)) corresponding to the trace object. For example, where the recordkeeping system 200 is structured to capture debits and credits in double-entry bookkeeping, verifying system 102 may confirm whether the originating entries of a trace added to the related evidentiary entries equal 0.

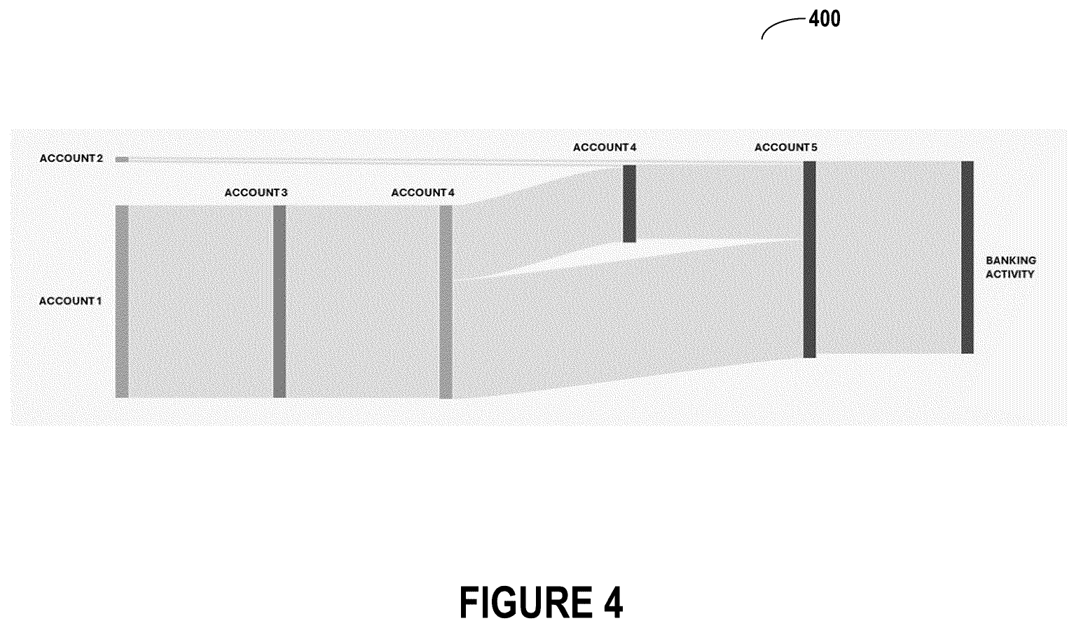

FIG. 4 is a Sankey diagram that provides a visualization 400 of trace completeness matches for data record entries from a recordkeeping system 200 and corresponding evidence system 210. The properties of trace objects may further be transformed into data used to generate the visualization 400 (e.g., a Sankey flow diagram) that visual represents a set of trace objects generated for recordkeeping system 200. Where the visualization 400 includes a Sankey flow diagram, for example, the visualization 400 visually illustrates confirmation of trace completeness and verification dispositions in accordance with the corresponding evidence. The visualization 400 may be visually indicate or distinguishes between different time-based data, e.g., whereby older transactions are shown on one side and newer transactions on the other. Different colors and sizes of the flows between bars (e.g., associated with specific account records) may be used within the visualization 400 to indicate verification status. Differences in account bar heights versus flow heights within the visualization 400 may be used to indicate incomplete traces (e.g., traces that stop before evidence is collected or where evidence is missing or not yet identified). The visualization 400 therefore condenses into a visual summary all the trace objects generated and evaluated for the data entries of a particular recordkeeping system 200, including the respective completeness, verification dispositions, and time-based progress. The visualization 400 may further be provided over cloud communication network 108 by verifying system 102 to designated recipient devices either periodically or upon request.

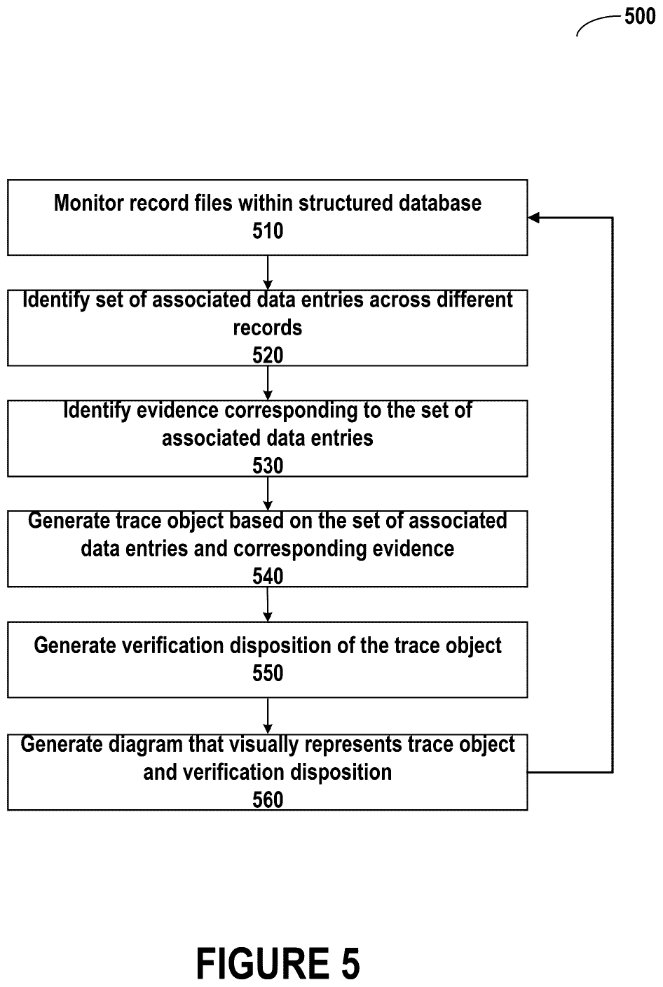

FIG. 5 is a flowchart illustrating an exemplary method 500 for tracing digital data entry matches and evidence. Method 500 may be performed by verifying system 102 in communication with a recordkeeping system (e.g., recordkeeping system 110, 112, or 200) and one or more corresponding evidence systems (e.g., evidence system 120, 122, or 210). The method 500 may be embodied as executable instructions in a non-transitory computer readable storage medium. The instructions of the storage medium may be executed by a processor (or processors) to cause various hardware components of a computing device hosting or otherwise accessing the storage medium to effectuate the method. The steps identified in FIG. 5 (and the order thereof) are exemplary and may include various alternatives, equivalents, or derivations thereof including but not limited to the order of execution of the same.

In step 510, verifying system 102 may monitor the record files within a structured database such as may reside or be embodied by recordkeeping system 200. Such monitoring may occur remotely over a cloud communication network 108, as well as occur over time. During that time, recordkeeping system 200 may update one or more record files to include new data entries that store data regarding relevant subject matter. Depending on the underlying subject matter, data entries may be created across multiple different record files within the data structure of recordkeeping system 200. Verifying system 102 may monitor the record files to determine when there are data entries within the record files that have not yet been associated with any trace object. When verifying system 102 identifies any unassociated data entries, method 500 may proceed to step 520. When verifying system 102 is newly tasked with monitoring a recordkeeping system 200 (e.g., such as illustrated n FIG. 2A), all data entries in recordkeeping system 200 may be determined to be currently unassociated and thus subject to analysis, evidence location, tracing, verification, and inclusion in the summary visualization as discussed in relation to the other steps of method 500.

In step 520, a set of different data entries—within the same record file and/or across different record files in recordkeeping system 200—may be identified by verifying system 102 as being associated with each other, e.g., by virtue of characterizing or otherwise describing the same or different parts of the same subject matter. As the data entries themselves may not store the same values or other data, verifying system 102 may use other information such as contextual information to determine associations between the data entries identified for the set. FIG. 2B illustrates using connecting lines that different sets of data entries across different records of recordkeeping system 200 may be associated with each other.

In step 530, verifying system 102 may identified evidence corresponding to the set of associated data entries. The corresponding evidence may be found in evidence files maintained by an independent, third-party system such as evidence system 210. Similar to the associations identified by verifying system 102 in step 520, verifying system 102 may use various contextual information to identify one or more evidence files stored at evidence system 210 that include evidence data entries corresponding to the set of data entries identified in step 520. The evidence data entries may include data in the same or different form as recordkeeping system 200, but that otherwise may be used to determine whether the data entries in the set are accurate. FIG. 2B illustrates, for example, that different sets of associated data entries within recordkeeping system 200 may further be associated with corresponding evidence data entries in an evidence record at evidence system 210.

In step 540, verifying system 102 may generate a new data structure, i.e., the trace object based on the set of associated data entries and correspondence evidence data entries. Unlike the data structure of recordkeeping system 200 (which is shown as being structured so as to maintain separate record files for different accounts), the traces may include data entries from across different record files and systems. A trace object may be generated for each set of data entries determined to be associated from across both recordkeeping system 200 and evidence system 210. FIG. 2C and FIGS. 3A-C illustrate the different traces that may be generated based on the different sets of data entries and system sources thereof.

In step 550, verifying system 102 may generate a verification disposition for each trace object. Verifying system 102 may initially determine that a particular trace object is complete with respect to the set of data entries identified as being associated, which may include verifying certain parameters of the trace object (e.g., that a defined subset of the entries from recordkeeping system 200 add up or otherwise comply with internal requirements, that the subset(s) in combination add up or otherwise comply with internal requirements, that data entries of a same transaction is associated with only one trace object, etc.). In some instances, completeness may be determined based on quality metrics generated for the data entries of the trace object. Once a trace object is determined to be complete, verifying system 102 may generate a verification disposition based on a comparison of the set of associated data entries and the corresponding evidence entries associated with the trace object. Where there may be mismatches or other indications of incorrect data, verifying system 102 may automatically send notifications to designated recipient devices to flag such indications. FIGS. 3A-C illustrates different trace objects with their respective completeness status and verification dispositions.

In step 560, verifying system 102 may generate a visualization 400 that summarizes the collective set of trace objects generated for a recordkeeping system 200, as well as their respective completeness, verification dispositions, and progress over time. As illustrated in FIG. 4, visualization 400 may include a Sankey diagram that uses flows and bars in different colors, sizes, and positions, etc., to convey information regarding the data entries of recordkeeping system 200, whether the data entries are backed up with corresponding evidence, and status of completeness and verification over time.

Following performance of step 560, the method may, verifying system 102 may return to step 510 for further monitoring of recordkeeping system 200 to determine whether there remains any new or otherwise unassociated data entries for which a new or existing trace object may need to be generated and associated therewith. As additional trace objects are generated, completed, and used to verify data entries over time, the visualization 400 may also be updated to reflect the additional trace objects generated for recordkeeping system 200.

FIG. 6 illustrates an exemplary computing system 600 that may be used to implement an embodiment of the present invention. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A system for tracing records across different systems, the system comprising:
a communication interface that communicates over a communication network to monitor data stored at a recordkeeping system that includes a data structure storing a plurality of record files, each record file including a plurality of data entries; and
a processor that executes instructions stored in memory, wherein the processor executes the instructions to:
identify a set of associated data entries from across different record files in the data structure,
identify one or more evidence entries stored at an evidence system, the evidence entries identified as corresponding to the set of associated data entries,
generate a trace object that is defined based on the set of associated data entries and the corresponding evidence entries,
generate a verification disposition for the trace object based on a comparison of the set of associated data entries to the corresponding evidence entries, and
generate a diagram that visually represents trace status for the record files in the recordkeeping system, wherein the diagram includes a plurality of trace objects including the defined trace object and corresponding verification dispositions including the generated verification disposition.

2. The system of claim 1, wherein the trace object has a different data structure than the recordkeeping system.

3. The system of claim 1, wherein the processor generates a verification disposition for another trace object by determining that another set of associated data entries does not correspond to evidence entries provided by evidence system.

4. The system of claim 1, further comprising memory that stores contextual information regarding the recordkeeping system, wherein the processor identifies that the set of data entries are associated based on the contextual information.

5. The system of claim 4, wherein the contextual information includes one or more of account associated with one or more of the set of data entries, a type of the account, a type of record, and a type of data structure.

6. The system of claim 1, wherein the processor executes further instructions to:
identify one or more differences within the set of data entries,
generate one or more quality metrics, and
assign a confidence score regarding completeness of the verification disposition.

7. The system of claim 1, wherein the trace objects in the diagram correspond to all transactions associated with the record files in the recordkeeping system.

8. The system of claim 1, wherein the trace objects correspond to a plurality of transactions that occur over time, and wherein the diagram visually distinguishes between an older transaction and a newer transaction.

9. The system of claim 1, wherein another trace object generated for another set of associated data entries within the recordkeeping system is associated with a different verification disposition, and wherein the diagram visually distinguishes between the verification disposition of the generated trace object and the different verification disposition of the other trace object.

10. The system of claim 1, wherein another trace object generated for another set of associated data entries within the recordkeeping system is associated with a different completion status, and wherein the diagram visually distinguishes between a completion status of the generated trace object and the different completion status of the other trace object.

11. A method for tracing records across different systems, the method comprising:
monitoring data stored at a recordkeeping system over a communication network, wherein the recordkeeping system includes a data structure storing a plurality of record files, each record file including a plurality of data entries;
identifying a set of associated data entries from across different record files in the data structure;
identifying one or more evidence entries stored at an evidence system, the evidence entries identified as corresponding to the set of associated data entries;
generating a trace object that is defined based on the set of associated data entries and the corresponding evidence entries;
generating a verification disposition for the trace object based on a comparison of the set of associated data entries to the corresponding evidence entries; and
generating a diagram that visually represents trace status for the record files in the recordkeeping system, wherein the diagram includes a plurality of trace objects including the defined trace object and corresponding verification dispositions including the generated verification disposition.

12. The method of claim 11, wherein the trace object has a different data structure than the recordkeeping system.

13. The method of claim 11, wherein generating a verification disposition for another trace object includes determining that another set of associated data entries does not correspond to evidence entries provided by evidence system.

14. The method of claim 11, further comprising storing contextual information in memory regarding the recordkeeping system, wherein identifying that the set of data entries are associated is based on the contextual information.

15. The method of claim 14, wherein the contextual information includes one or more of account associated with one or more of the set of data entries, a type of the account, a type of record, and a type of data structure.

16. The method of claim 11, further comprising:
identifying one or more differences within the set of data entries;
generating one or more quality metrics; and
assigning a confidence score regarding completeness of the verification disposition.

17. The method of claim 11, wherein the trace objects in the diagram correspond to all transactions associated with the record files in the recordkeeping system.

18. The method of claim 11, wherein the trace objects correspond to a plurality of transactions that occur over time, and wherein the diagram visually distinguishes between an older transaction and a newer transaction.

19. The method of claim 11, wherein another trace object generated for another set of associated data entries within the recordkeeping system is associated with a different verification disposition, and wherein the diagram visually distinguishes between the verification disposition of the generated trace object and the different verification disposition of the other trace object.

20. The method of claim 11, wherein another trace object generated for another set of associated data entries within the recordkeeping system is associated with a different completion status, and wherein the diagram visually distinguishes between a completion status of the generated trace object and the different completion status of the other trace object.

21. A non-transitory, computer-readable storage medium having embodied thereon a program executable by a processor to perform a method for tracing records across different systems, the method comprising:
monitoring data stored at a recordkeeping system over a communication network, wherein the recordkeeping system includes a data structure storing a plurality of record files, each record file including a plurality of data entries;
identifying a set of associated data entries from across different record files in the data structure;
identifying one or more evidence entries stored at an evidence system, the evidence entries identified as corresponding to the set of associated data entries;
generating a trace object that is defined based on the set of associated data entries and the corresponding evidence entries;
generating a verification disposition for the trace object based on a comparison of the set of associated data entries to the corresponding evidence entries; and
generating a diagram that visually represents trace status for the record files in the recordkeeping system, wherein the diagram includes a plurality of trace objects including the defined trace object and corresponding verification dispositions including the generated verification disposition.
